(19) United States
(12) Patent Application Publication
(10) Pub. No.: US 2009/0306246 A1
(43) Pub. Date: Dec. 10, 2009

(54) CROSSLINKED COMPOSITION COMPRISING A CORE/SHELL COPOLYMER, METHOD OF OBTAINING SAME AND USES THEREOF

(76) Inventors: Laurent Gervat, Les Clayes Sous Bois (FR); Gilles Meunier, Mazerolles (FR); Christophe Navarro, Lahonce (FR); Elisabeth Bay, Hagetmau (FR); Laure Mauboules, Billere (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/096,237

(22) PCT Filed: Dec. 1, 2006
(86) PCT No.: PCT/FR2006/051272

§ 371 Date: Oct. 6, 2008

Related U.S. Application Data
(60) Provisional application No. 60/765,460, filed on Feb. 3, 2006.

(30) Foreign Application Priority Data
Dec. 7, 2005 (FR) 0512400

(51) Int. Cl. C08L 33/12

(52) U.S. Cl. 523/201; 525/227

(57) ABSTRACT

The invention relates to is a crosslinked composition containing in parts by weight: 20 to 100 parts of at least one elastomer (I), 2 to 50 parts of at least one core/shell copolymer (II), and 0 to 100 parts of at least one thermoplastic polymer (III). The invention also relates to a method of producing one such crosslinked composition, which is characterized in that it consists in: mixing an elastomer and a core/shell copolymer optionally in the presence of: a grafted polyolefin, a plasticizer, fillers and/or additives, and a suitably-selected crosslinking system, and subsequently crosslinking said mixture at a suitable temperature. In a preferred embodiment of the invention, the mixture is crosslinked at a temperature of between 150 and 320° C. The invention method be carried out in an internal mixer, or, alternately, in a twin-screw extruder or a Buss®-type co-kneader. Depending on the case, the resulting mass is calendared or extruded, cooled and subsequently granulated. The granules thus obtained are then ready to be transformed, by means of heating, into sheets, plates, extrusions, tubes or other desired products. The invention further relates to the use of one such composition in the production of ducts, pipes, tubing, couplers or similar for conveying fluids, such as the fluid transfer conduits, pipes and other elements which are used in the automobile industry in braking, cooling, steering and air-conditioning systems. The inventive crosslinked composition can also be used in the production of belts, tires, electrical cable sheaths, and shoe soles.”

### FIELD OF THE INVENTION

The present invention relates to a crosslinked composition comprising a core-shell copolymer, to a process for obtaining it and to its uses. In particular, it describes a crosslinked composition comprising an elastomer and a core-shell copolymer, a process for obtaining it based on high-temperature crosslinking, and its uses.

The crosslinked composition of the invention is applicable in the manufacture of certain articles, such as tyres, isolating seals and gaskets, and pipes for transporting fluids such as those used in the automobile industry, for example in the brake or cooling circuits. Tyre technology is described in applications WO 00/05300, WO 00/05301 and EP 501 227, the content of which is incorporated in the present application. Examples of tyre parts that can benefit from these compositions that may be mentioned include, non-limitingly, the crown (padding on the bead or apex), the sidewalls, the carcass and rubber mixes containing steel wires, the shoulders, but also the beads, the impermeable plies, the chafers and the tread. Other applications may make use of the compositions of the invention, such as for the manufacture of belts (such as transmission belts), electrical cable jackets, shoe soles, seals, resilient links, pipes and hoses, membranes or anti-vibration devices, and also for applications in the mechanical industry, in the aeronautical industry, in transportation, in the electrical industry, in the building industry, in medicine and in pharmacy, and in the nuclear industry. In these various applications, the elastomers may of course be combined with other materials, such as metals, textiles and certain plastics.

In one particular embodiment, the crosslinked compositions of the invention may be converted like thermoplastics. This is because, for some applications (isolating seals and gaskets or fluid transfer pipes), it is desirable to have materials which, while still having properties similar to those of elastomers, and especially an ability to withstand large deformations without breaking and the capability of returning to their initial geometry after the application of tensile or compressive forces, even repeatedly applied, and also good heat resistance, chemical resistance and weatherability, can be processed by the techniques and equipment used by thermoplastic converters, and to do so mainly in order to allow these articles and the scrap produced during their manufacture to be recycled, which recycling is not permitted when elastomers are used.

### PRIOR ART AND THE TECHNICAL PROBLEM

U.S. Pat. No. 4,130,535 discloses “thermoplastic elastomers” based on polyolefins that have a structure consisting of an uncrosslinked polypropylene matrix and crosslinked nodules of an ethylene-propylene-diene monomer (EPDM) terpolymer, so as to have, at the operating temperature (which is below the melting point of polypropylene) a behaviour similar to that of elastomers after vulcanization, while heating them above this melting point allows them to be processed like thermoplastics. Although these materials do have a number of properties equivalent to those of elastomers, they exhibit a high tension set (greater than 50%) at temperatures above 100° C., which makes their use hardly appropriate for the manufacture of articles intended to be used in regions where temperatures above 100° C. prevail, as may be the case for isolating seals and gaskets or else pipes, hoses, tubes and the like designed to transport fluids in the engine coMPartment of a motor vehicle.

To solve this problem, Patent EP 0 840 763 A1 proposes a solution based on the use of a crosslinked elastomer of the thermoplastic conversion type obtained by crosslinking a blend, denoted hereafter by “Vegaprene®”, comprising a poly(octene/ethylene)-based elastomer obtained by metallocene catalysis and a maleic-anhydride-grafted polyolefin. Although this solution is satisfactory, it nevertheless remains limited to certain applications.

This is because the properties of the blends are in general different from those expected by simple linear interpolation of the properties of the constituents taken separately (elastomers and plastics). Synergy effects may sometimes be present, but other cases exist in which the properties are slightly inferior. This may be connected with the morphology of the various phases, the distribution of the fillers and plasticizers, the nature of the interfaces or the distribution of the vulcanization bridges in the various phases. To alleviate these effects it is general practice to use coMPatibilizers or co-agents, but these are expensive and difficult to incorporate into the blends.

In particular in the case of repeated-stress resistance properties, the fatigue behaviour of the compounds is of paramount importance. This may be achieved using co-agents such as zinc methacrylate. However, because of the polarity of this compound it is difficult to disperse it in the blends. Furthermore, its high reactivity with metal at high temperature results in blends that adhere to the mixing equipment. Consequently, it is little used. Another useful property may be the high-elongation resistance. This property is difficult to obtain with the blends described in EP 0 840 763 A1.

Finally, in certain cases the improvement in compression set, generally termed S_{C}, obtained by applying the method described in EP 840 763 A1 may prove to be insufficient.

To solve the problems described above, and many others, a solution has been found based on a crosslinked composition comprising at least one elastomer and at least one core-shell copolymer and optionally a thermoplastic polymer. This solves the aforementioned problems without adversely modifying the other mechanical characteristics of the blends (dynamic properties, dissipation, hardness, rebound, etc.). The polymer blend is easy to disperse using the method described in the present application. In addition, it has the advantage of not adhering to the equipment.

Another approach for solving these problems has been described in Patent Application WO 2005/082996, which discloses a crosslinked composition comprising:
at least one elastomer;
at least one triblock copolymer; and
at least one thermoplastic polymer.

As this solution is satisfactory, a person skilled in the art would have no reason to substitute the triblock copolymer with a core-shell copolymer. The present invention is therefore an alternative to the solution of WO 2005/082996, making it possible to enlarge the range of products and applications associated with this technology.

### BRIEF DESCRIPTION OF THE INVENTION

The first subject of the invention is therefore a crosslinked composition comprising, in parts by weight, the following different constituents:
>20 to 100 parts of at least one elastomer (I);
>2 to 50 parts of at least one core-shell copolymer (II); and
0 to 100 parts of at least one thermoplastic polymer (III),
   the components (I), (II) and (III) being different in chemical nature and/or of different structure.

According to the invention, the elastomer (I) and the thermoplastic (III) are not of core-shell form.

The subject of the present invention is also a process for producing a crosslinked composition as defined above, characterized in that it comprises:
the blending of an elastomer (I) with a core-shell copolymer (II) optionally in the presence of a thermoplastic polymer (III), in particular a grafted polyolefin, a plasticizer, fillers and/or additives, and a suitably chosen crosslinking system,
followed by the crosslinking of this blend at a suitable temperature.

In a preferred method of implementing the process according to the invention, the temperature at which the crosslinking is carried out is between 150 and 320° C.

This process may be carried out in an internal mixer, or, as a variant, in a twin-screw extruder or a Buss® co-kneader. The resulting mass is, in this case, calendared or extruded, then cooled and granulated. The granules thus obtained are ready to be converted (by heating these granules) into sheets, plates, extrusions, tubes or other desired products.

The subject of the present invention is also the use of a crosslinked composition as defined above for the production of seals and/or gaskets for isolating and/or for sealing, such as those employed for thermal or acoustic insulation and/or for sealing against water and moisture, especially in buildings, and for the motor vehicle industry (for example door seals).

The subject of the present invention is also the use of such a composition in the production of pipes, tubes, hoses, nozzles, fittings or the like for transporting fluids. As examples, mention may be made of pipes, hoses and other elements designed to convey fluids used by the motor vehicle industry in brake, cooling, power-steering or air-conditioning circuits. Thus, the subject of the invention is especially seals and gaskets for isolating and/or for sealing that comprise the crosslinked composition defined above. In addition, however, the invention covers ducts such as pipes, hoses, nozzles and fittings comprising the crosslinked composition defined above.

Mention may also be made of the use of the crosslinked composition of the invention in the production of belts, tyres, electrical cable jackets, and shoe soles.

According to the invention, the composition may contain one or more elastomers (I) associated with one or more core-shell copolymers (II) and optionally one or more thermoplastic polymers.

The Applicant has found, surprisingly, that the use of a core-shell copolymer blended with several elastomers (I) allows the use of elastomers that are normally chemically incoMPatible (for example a blend of natural rubber (NR) with 2-chloro-1,3-butadiene, usually called chloroprene (CR), by coMPatibilizing them. This advantage allows the composition of the invention to be used in a wide range of applications, greater than those of the compositions of the prior art. The term “coMpatibilize” is understood to mean that the physico-chemical properties of each of the elastomers are retained.

### DETAILED DESCRIPTION OF THE INVENTION

With regard to the elastomer (I), this may be chosen from the group comprising natural rubbers (NR), synthetic rubbers (BR), elastomers polymerized by metallocene catalysis, modified or unmodified polyolefin elastomers, ethylene-propylene rubbers (EPR), ethylene-propylene-diene monomers (EPDM), long-chain polyacrylates, such as polybutyl acrylate or poly(2-ethylhexyl acrylate), fluoroelastomers (FPM), such as tetrafluoroethylene-based copolymers, and silicone elastomers.

The term “synthetic rubber (BR)” is understood to mean conjugated polydienes such as polybutadiene, polyisoprene and their block or random copolymers, especially styrene-diene copolymers with a predominantly diene content.

For the purpose of the present invention, the expression “elastomer polymerized by a metallocene catalyst” is understood to mean any elastomer consisting of a homopolymer, copolymer or terpolymer polymerized by means of a metallocene catalyst, such as octene/ethylene polymers, also called polyoctenes, which are available from DuPont Dow Elastomers (DDE) under the trade name ENGAGE.

With regard to the core-shell copolymer (II), this is in the form of fine particles having an elastomer core and at least one thermoplastic shell, the particle size being generally less than 1 μm and advantageously between 50 and 300 nm. By way of example, of the core, mention may be made of isoprene homopolymers or butadiene homopolymers, isoprene-butadiene copolymers, copolymers of isoprene with at most 98 wt % of a vinyl monomer and copolymers of butadiene with at most 98 wt % of a vinyl monomer. The vinyl monomer may be styrene, an alkylstyrene, acrylonitrile, an alkyl(meth)acrylate, or butadiene or isoprene. The core of the core-shell copolymer may be completely or partly crosslinked. All that is required is to add at least difunctional monomers during the preparation of the core; these monomers may be chosen from poly(meth)acrylic esters of polyols, such as butylene di(meth)acrylate and trimethylolpropane trimethacrylate. Other difunctional monomers are, for example, divinylbenzene, trivinylbenzene, vinyl acrylate, vinyl methacrylate and triallyl cyanurate. The core can also be crosslinked by introducing into it, by grafting or as a comonomer during the polymerization, unsaturated functional monomers such as anhydrides of unsaturated carboxylic acids, unsaturated carboxylic acids and unsaturated epoxides. Mention may be made, by way of example, of maleic anhydride, (meth)acrylic acid and glycidyl methacrylate. The crosslinking may also be carried out by using the intrinsic reactivity of the monomers, for example the diene monomers.

The shell(s) are styrene homopolymers, alkylstyrene homopolymers or methyl methacrylate homopolymers, or copolymers comprising at least 70 wt % of one of the above monomers and at least one comonomer chosen from the other above monomers, another alkyl(meth)acrylate, vinyl acetate and acrylonitrile. The shell may be functionalized by introducing into it, by grafting or as a comonomer during the polymerization, unsaturated functional monomers such as anhydrides of unsaturated carboxylic acids, unsaturated carboxylic acids and unsaturated epoxides. Mention may be made, for example, of maleic anhydride, (meth)acrylic acid glycidyl methacrylate, hydroxyethyl methacrylate and alkyl(meth)acrylamides. By way of example, mention may be made of core-shell copolymers having a polystyrene shell and core-shell copolymers having a PMMA shell. The shell may also contain imide functional groups, either by copolymerization with a maleimide or by chemical modification of the PMMA by a primary amine. Advantageously, the molar concentration of the imide functional groups is 30 to 60% (relative to the entire shell). There are also core-shell copolymers having two shells, one made of polystyrene and the other, on the outside, made of PMMA. Examples of copolymers and their method of preparation are described in the following patents: U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928, U.S. Pat. No. 3,985,704 and U.S. Pat. No. 5,773,320.

Advantageously, the core represents in this invention, by weight, 5 to 90% of the core-shell copolymer and the shell 95 to 10%.

By way of example of a copolymer, mention may be made of that consisting (i) of 70 to 75 parts of a core comprising at least 93 mol % of butadiene, 5 mol % of styrene and 0.5 to 1 mol % of divinylbenzene and (ii) of 25 to 30 parts of two shells essentially of the same weight, the inner one made of polystyrene and the outer one made of PMMA.

Another example that may be mentioned has a core made of a butyl acrylate/butadiene copolymer and a shell made of PMMA.

All these core-shell copolymers are sometimes called soft/hard copolymers because the core is made of an elastomer.

It would not be outside the scope of the invention to use core-shell copolymers such as hard/soft/hard copolymers, that is to say copolymers having, in this order, a hard core, a soft shell and a hard shell. The hard parts may consist of the polymers of the shell of the above soft/hard copolymers and the soft part may consist of the polymers of the core of the above soft/hard copolymers.

For example, mention may be made of those described in EP 270 865 and those consisting, in the following order, of
a core made of a methyl methacrylate/ethyl acrylate copolymer;
a shell made of a butyl acrylate/styrene copolymer; and

a shell made of a methyl methacrylate/ethyl acrylate copolymer.

There are also other types of core-shell copolymer such as hard (core)/soft/semi-hard copolymers. CoMPared with the previous ones, the difference stems from the “semi-hard” outer shell which consists of two shells, namely the intermediate shell and the outer shell. The intermediate shell is a copolymer of methyl methacrylate, styrene and at least one monomer chosen from alkyl acrylates, butadiene and isoprene. The outer shell is a PMMA homopolymer or copolymer.

Mention may be made, for example, of those consisting, in the following order, of:
a core made of a methyl methacrylate/ethyl acrylate copolymer;
a shell made of a butyl acrylate/styrene copolymer;
a shell made of a methyl methacrylate/butyl acrylate/styrene copolymer; and
a shell made of a methyl methacrylate/ethyl acrylate copolymer.

With regard to the thermoplastic polymer (III), this is chosen for example from modified or unmodified polyolefins, polyamides, polyesters, thermoplastic polyurethanes, fluoropolymers and chlorinated polymers such as polyvinyl chloride (PVC). Advantageously, the thermoplastic polymer (III) is a functionalized polyolefin. Preferably, the thermoplastic polymer (III) is a grafted polyethylene chosen from the group comprising polyethylenes, polypropylenes and ethylene-propylene polymers grafted with acrylic acid, maleic anhydride or glycidyl methacrylate.

With regard to the constituents of the composition of the invention, the proportions of the elastomer (I), the core-shell copolymer (II) and the thermoplastic polymer (III) are advantageously 60 to 90 parts of (I), 5 to 20 parts of (II) and 48 to 5 parts of (III).

According to one embodiment of the invention, the contents of elastomer (I), core-shell copolymer (II) and thermoplastic polymer (III) of the composition are between 30 and 80% in the case of (I), 2 to 35% in the case of (II) and 5 to 80% in the case of (III).

According to a preferred embodiment of the invention, the contents of elastomer (I), core-shell copolymer (II) and thermoplastic polymer (III) of the composition are between 40 and 70% in the case of (I), 2 to 20% in the case of (II) and 10 to 70% in the case of (III).

### Other Constituents of the Composition:

Advantageously, the crosslinked composition according to the invention may also include a polyacrylic elastomer, such as an ethylene/acrylate/acrylic acid terpolymer or a styrene/acrylonitrile/acrylate terpolymer, which acts both as a UV stabilize and as a film-forming agent and which makes it possible to improve the surface appearance of the composition when it is processed by extrusion. When such a polyacrylic elastomer is used, it is preferably with a content of 2 to 20 parts by weight per 100 parts by weight of the elastomer/core-shell copolymer blend.

Also advantageously, the composition of the invention may contain, in addition, a plasticizer whose presence makes it possible to increase its melt flow index and thereby make it easier to process it, and to adjust the hardness of the products resulting from this processing, depending on the desired hardness value. Preferably, this plasticizer is a paraffinic plasticizer of the type of those sold by Total under the brand name PLAXENE or by Exxon under the brand name FLEXON, and is used in an amount of 5 to 120 parts by weight per 100 parts by weight of the elastomer/core-shell copolymer (II) blend and optionally of the elastomer/core-shell copolymer (II)/thermoplastic polymer (III) blend. However, other plasticizers such as a polyalkylbenzene may also be suitable.

The composition may also include fillers of the light-coloured type (silicas, carbonates, clays, chalk, kaolin, etc.) or carbon blacks. The use of the latter fillers proves to be particularly advantageous as they make it possible not only to adjust certain mechanical properties of the composition according to the invention, such as the tensile strength and the tensile modulus, but also to give it excellent UV resistance. When such fillers are present in the composition, their content is advantageously from 5 to 100 parts by weight per 100 parts by weight of the elastomer (I)/core-shell copolymer (II)/optional thermoplastic polymer (III) blend.

When it is necessary to add fillers, and especially carbon black, into the composition so as to give them good mechanical properties and/or UV resistance (properties needed for some applications), the Applicant has found, surprisingly, that the composition based on a core-shell polymer, which facilitates the processing of the filled composition, reduces its heat-up when blending its various constituents and reduces its viscosity, coMPared with filled compositions of the prior art.

The composition may further contain a certain proportion of triblock copolymers, for example in an amount of 0.01 to 200 and especially 0.1 to 10% of the composition.

The crosslinked composition may furthermore contain other additives conventionally employed in the polymer industry such as, for example, antistatic agents, lubricants, antioxidants, coupling agents, pigments, dyes, processing aids and adhesion promoters, depending on the properties that it is desired to give it, provided that, of course, these additives are coMPatible with the other constituents of the composition of the invention.

The composition according to the invention is said to be “crosslinked” because its production involves crosslinking the elastomer that forms part of its composition. Consequently, the composition according to the invention contains, before crosslinking, at least one crosslinking system comprising one or more crosslinking agents suitably chosen according to the nature of its constituent polymers, especially its constituent elastomers, and one or more crosslinking promoters, the function of which is to activate the crosslinking reaction kinetics and increase the crosslinking density. The crosslinking agent is chosen according to the temperature for processing and crosslinking the constituent elastomers of the composition.

According to a preferred embodiment of the invention, this crosslinking system comprises, as crosslinking agent(s), one or more organic peroxides chosen from the group comprising dicumyl peroxide, 1,3-bis(t-butylperoxyisopropyl)benzene, 2,5-dimethyl-2,5-bis(t-butylperoxy)hexane and 1,1-bis(t-butylperoxy)-3,3,5-trimethylcyclohexane and, as crosslinking promoter(s), one or more compounds chosen from the group comprising zinc oxide, stearic acid, N,N-m-phenylenedimaleimide, triallyl or triisoallyl cyanurates, methacrylates (such as tetrahydrofurfuryl or 2-phenoxyethyl methacrylates), dimethacrylates (such as ethylene glycol, tetraethylene glycol, 1,4-butanediol or zinc dimethacrylates), trimethacrylates (such as trimethylolpropane trimethacrylate), diacrylates (such as zinc diacrylate) and triacrylates.

According to another preferred embodiment of the invention, the crosslinking system is a sulphur-based system that comprises, apart from zinc oxide and/or stearic acid as crosslinking promoter(s), one or more sulphur-donor accelerators such as 4,4-dithiomorpholine, tetramethylthiuram disulphide, dipentamethylenethiuram tetrasulphide or zinc dibutyldithiocarbamate, and optionally an anti-reversion agent such as 1,3-bis(citraconimidomethyl)benzene.

According to one particularly preferred embodiment of the invention, the crosslinking system comprises, as crosslinking agent, a phenolic resin chosen from reactive alkylated methylphenol-formaldehyde and bromomethylphenol-formaldehyde resins and, as crosslinking promoter, a chlorinated polymer such as a chlorinated or chlorosulphonated polyethylene or a polychloroprene, optionally combined with zinc oxide and/or stearic acid. The latter crosslinking system makes it possible to obtain elastomers which, apart from having extremely satisfactory mechanical properties and tension and compression set values, are characterized by an attractive surface appearance.

In all cases, the crosslinking agent or agents are preferably present in the formulation in an amount from 1 to 10 parts by weight per 100 parts by weight of the elastomer (I)/core-shell copolymer (II)/optional thermoplastic polymer (III) blend, whereas the crosslinking promoters are preferably present in an amount from 0.5 to 12 parts by weight per 100 parts by weight of the blend.

When the vulcanization system is a sulphur-based system, the sulphur-donor accelerator or accelerators are preferably present in the formulation in an amount from 1 to 7 parts by weight per 100 parts by weight of the elastomer (I)/core-shell copolymer (II)/optional thermoplastic polymer (III) blend.

According to the invention, the crosslinking of the composition may be carried out by means of two crosslinking systems. As an example, it is possible to use a sulphur-based crosslinking system combined with a crosslinking system based on organic peroxides or a crosslinking system based on a phenolic resin and a crosslinking system based on organic peroxides.

Depending on the nature and the proportions of (I) and (III), the compositions of the invention may be mentioned using the techniques and equipment employed for processing thermoplastics, namely thermoforming, injection moulding, extrusion, forming, etc. In this particular case, the compositions of the invention are referred to as being “thermoplastic-processable”. As examples of such compositions, mention may be made of those in which the elastomer I consists of a homopolymer, copolymer or terpolymer polymerized by means of a metallocene catalyst and the polymer III is present. Advantageously, the polymer III is a functionalized polyolefin, preferably a grafted polyolefin. It may be chosen from the grafted polyolefins mentioned above. For example, the I/III blends known by the name “Vegaprene®”, such as those described for example in the patents FR 2 667 016, WO 97/44390, U.S. Pat. No. 4,130,535 or EP 0 840 763 B1, may be mentioned.

The crosslinked thermoplastic-processable compositions according to the invention, while still exhibiting mechanical properties, in terms of hardness, tensile strength and elongation at break, which are equivalent to those of the abovementioned thermoplastic elastomers of the prior art, have better compression set and tension set properties than those elastomers. This advantage is observed not only in the short term but also in the long term, where the compositions according to the invention have a lower tendency to creep.

With regard to the production process, this comprises the compounding of at least one elastomer (I), at least one core-shell copolymer (II) optionally in the presence of a thermoplastic polymer (III), a plasticizer and fillers and additives, and the crosslinking of this compound by an appropriate crosslinking system at a suitably chosen temperature.

According to one particularly preferred method of implementation, the production process according to the invention comprises the following:
a) the elastomer, core-shell copolymer (II) and the crosslinking system, optionally in the presence of the thermoplastic polymer, the polyacrylic elastomer, the plasticizer, the fillers and/or the additives, are compounded;
b) this compound is heated to a temperature of between 150 and 320° C.; and
c) this temperature is maintained for a time of between 1 and 15 minutes.

### EXAMPLES

Various formulations were prepared according to the following method: the ingredients needed to produce the crosslinked composition were introduced into an internal mixer and compounded with suitable shear. While continuing the shearing, the internal temperature of the mixer was raised to 170° C. and, when this temperature was reached, the compounds were maintained thereat for about 5 minutes. The compounds thus obtained on exiting the mixer were cooled and granulated.

The following were determined:
the Shore A hardness according to the method described in the NF standard T 46-052;
   the tensile strength (TS) and the elongation at break (EB), according to the method described in the ISO 37 standard, of each of the compositions thus produced, and also:
   the compression set (S_{C}) after being compressed by 25% for 22 hours at 100° C., according to the method described in the ISO 815 standard; and
   the tension set (S_{T}) after being stretched by 20% for 70 hours according to the method described in the ISO 2285 standard.

The following tables give the compositions studied, expressed in parts by weight, and the results obtained.

In the following tables:
ML and MH denote the minimum and maximum torques, Max-Min denotes the difference between these two torques, and tc(5), tc(50) and tc(95) denote the times to reach 5%, 50% and 95% of the maximum torque respectively;
MBS1 denotes a core-shell copolymer having an essentially butadiene/styrene-based core and a PMMA shell, sold by Arkema®;
MBS2 denotes a 50/50 wt % core-shell copolymer composed of an essentially butadiene/styrene-based core and a PMMA shell; and

MBS3 denotes a core-shell copolymer made up essentially from a substructured core, consisting of predominantly a PMMA central portion with a butadiene-based peripheral layer, and from a PMMA shell.

The compounding of the rubber was carried out in two steps using a direct method: the first step used an internal mixer in which the NR was preheated for one minute with a rotor temperature of 60° C. and a rotor speed of 60 rpm. Next, all the reactants with the exception of the vulcanization system were added and the speed of the rotors was increased to 80 rpm, taking measures to ensure that the compounding temperature did not exceed 140° C. The compound was dropped after 6 minutes. The peak temperature of the compound was about 160° C. The second step consisted in manually working the rubber on an open mixer using a cutting tool. The temperature of the rolls was 40° C. and the coefficient of friction 1.2. The vulcanization system was incorporated and at least three passes were made in the end. This working lasted about twenty minutes. The results are given in Table 1 below:

TABLE 1

| | | A | C |
|---|---|---|---|
| Natural rubber (NR) | phe | 80 | 80 |
| Butadiene (BR) | phe | 20 | 20 |
| MBS1 | phe | | 10 |
| ZnO | phe | 5 | 5 |
| Stearic acid | phe | 2 | 2 |
| Paraffin | phe | 2 | 2 |
| Black | phe | 35 | 35 |
| Plasticizer | phe | 4 | 4 |
| Protective agent | phe | 4.5 | 4.5 |
| Accelerators | phe | 1.5 | 1.5 |
| Sulphur | phe | 1.55 | 1.55 |
| MDR rheometer, 160° C.: | | | |
| ML | dNm | 0.53 | 0.52 |
| MH | dNm | 9.52 | 8.37 |
| Max-Min | dNm | 8.99 | 7.85 |
| tc(5) | min | 2.13 | 2.25 |
| tc(50) | min | 3.32 | 3.72 |
| tc(95) | min | 7.67 | 8.15 |
| Physical properties: | | | |
| Hardness (Shore A) | | 48 | 49 |
| Rebound | % | 77 | 73 |
| S_{c} (22 h at 125° C.) | % | 47 | 49 |
| Stress at 50% | MPa | 0.8 | 0.9 |
| Stress at 100% | MPa | 1.4 | 1.6 |
| Stress at 200% | MPa | 2.9 | 3.2 |
| Stress at 300% | MPa | 5.4 | 5.9 |
| Stress at break | MPa | 17.2 | 16 |
| Standard deviation | MPa | 0.9 | 0.9 |
| Elongation at break | % | 542 | 513 |
| Standard deviation | % | 22 | 21 |
| Tear strength | N/mm | 20.18 | 26.86 |
| Standard deviation | N/mm | 0.92 | 4.75 |

This table shows that there is a considerable improvement in the Delft tear strength, which is an indicator of better behaviour in fatigue (under repeated mechanical stressing) and without the other properties important for the application (S_{C} and rebound) being modified. This is an improvement made to the crosslinked formulations, whether or not they have a thermoplastic processing mode.

In Table 2 below, the compounds were produced by the reverse method, that is to say, in the case of the first step, by firstly introducing all the additives and then the elastomers. The internal mixer was used at 30° C. with a rotor speed of 120 rpm. The working lasted about 7 minutes. The second step was similar to the procedure used for the NR. Scorch corresponds to premature vulcanization of a rubber compound.

TABLE 2

| | | A | C | D | E |
|---|---|---|---|---|---|
| EPDM (at 5% of | phe | 175 | 175 | 175 | 175 |
| ethylidene norbornene | | | | | |
| (ENB)) | | | | | |
| Filler | phe | 80 | 80 | 80 | 80 |
| Plasticizer | phe | 10 | 10 | 10 | 10 |
| Additives | phe | 6 | 6 | 6 | 6 |
| Vulc. system S | phe | 1.43 | 1.43 | 1.43 | 1.43 |
| MBS1 | phe | | 18 | | |
| MBS2 | phe | | | 18 | |
| MBS3 | phe | | | | 18 |
| Mooney viscometer | | | | | |
| 100° C. viscosity | MU | 61.5 | 67.3 | 67.8 | 66.9 |
| Scorch, t5-125° C. | min | 14.12 | 21.31 | 20.08 | 16.47 |
| MDR rheometer, 170° C. | | | | | |
| ML | dNm | 1.37 | 1.55 | 1.33 | 1.49 |
| MH | dNm | 8.79 | 5.26 | 5.22 | 7.24 |
| Max-Min | dNm | 7.41 | 3.71 | 3.89 | 5.75 |
| tc(5) | min | 1.1 | 1.32 | 1.28 | 1.13 |
| tc(50) | min | 2.08 | 2.07 | 2.12 | 1.97 |
| tc(95) | min | 5.58 | 4.42 | 4.61 | 4.48 |
| Physical properties: | | | | | |
| Hardness (Shore A) | | 46 | 42 | 43 | 48 |
| Rebound | % | 65 | 60 | 60 | 63 |
| S_{c} (22 h at 125° C.) | % | 52 | 53 | 51 | 50 |
| Stress at 50% | MPa | 0.7 | 0.7 | 0.7 | 0.7 |
| Stress at 100% | MPa | 1.3 | 0.8 | 0.9 | 1.2 |
| Stress at 200% | MPa | 3.2 | 1.7 | 2.1 | 2.7 |
| Stress at 300% | MPa | 5.7 | 2.9 | 3.5 | 4.5 |
| Stress at break | MPa | 19.5 | 10.9 | 12.5 | 11 |
| Standard deviation | MPa | 0.6 | 0.5 | 0.5 | 0.8 |
| Elongation at break | % | 693 | 875 | 798 | 617 |
| Standard deviation | % | 9 | 17 | 27 | 39 |
| Tear strength | N/mm | 22.02 | 22.09 | 23.57 | 23.13 |
| Standard deviation | N/mm | 0.29 | 0.38 | 0.28 | 0.41 |

These results show that, despite a reduction in the torque difference Max-Min, there is an improvement in the elongation and the Delft tear strength, this being important for fitting the part and for its resistance.

TABLE 3

| | | F | H | I | J |
|---|---|---|---|---|---|
| EPDM (10% ENB level) | phe | 115 | 115 | 115 | 115 |
| MBS1 | phe | | 18 | | |
| MBS2 | phe | | | 18 | |
| MBS3 | phe | | | | 18 |
| Filler | phe | 78 | 78 | 78 | 63 |
| Plasticizer | phe | 15 | 15 | 15 | 12 |
| Additives | phe | 6 | 6 | 6 | 6 |
| Vulc. system S | phe | 3.6 | 3.6 | 3.6 | 3.6 |
| Mooney viscometer | | | | | |
| 100° C. viscosity | MU | 96.6 | 104.5 | 104.9 | 110.6 |
| Scorch, t5-125° C. | min | 9.93 | 15.22 | 13.42 | 13.03 |
| MDR rheometer, 170° C. | | | | | |
| ML | dNm | 2 | 2.35 | 2.25 | 2.35 |
| MH | dNm | 27.09 | 12.53 | 12.47 | 20.18 |
| Max-Min | dNm | 25.08 | 10.18 | 10.23 | 17.83 |
| tc(5) | min | 0.88 | 1 | 0.98 | 1 |
| tc(50) | min | 1.57 | 1.7 | 1.55 | 1.68 |
| tc(95) | min | 4.23 | 4.88 | 3.75 | 3.73 |
| Physical properties: | | | | | |
| Hardness (Shore A) | | 66 | 62 | 63 | 68 |
| Rebound | % | 56 | 52 | 51 | 50 |
| S_{c} (22 h at 125° C.) | % | 50 | 46 | 48 | 47 |
| Stress at 50% | MPa | 1.9 | 1.6 | 1.6 | 2.1 |
| Stress at 100% | MPa | 4 | 2.9 | 2.8 | 4.2 |
| Stress at 200% | MPa | 9.2 | 6.7 | 6.4 | 9.4 |
| Stress at 300% | MPa | 14.2 | 10.4 | 9.8 | 13.7 |
| Stress at break | MPa | 16.1 | 16.1 | 15.5 | 15.8 |
| Standard deviation | MPa | 1.5 | 0.6 | 0.8 | 0.9 |
| Elongation at break | % | 344 | 439 | 462 | 354 |
| Standard deviation | % | 36 | 17 | 15 | 22 |
| Tear strength | N/mm | 23.56 | 25.92 | 25.67 | 25.2 |
| Standard deviation | N/mm | 1.17 | 0.48 | 0.61 | 0.76 |

These results (Table 3) show that, despite a reduction in the torque difference Max-Min, there is an improvement in the elongation and the Delft tear strength, this being important for fitting the part and for its resistance.

TABLE 4

| | | A | D |
|---|---|---|---|
| EPDM | phe | 100 | 100 |
| PP | phe | 50 | 50 |
| Plasticizer | phe | 30 | 30 |
| Filler | phe | 30 | 30 |
| Peroxides | phe | 4 | 4 |
| Processing aids | phe | 10.5 | 10.5 |
| MBS1 | phe | | 15 |
| Physical properties: | | | |
| Hardness (Shore A) | | 81 | 81 |
| S_{c} (22 h at 125° C.) | % | 61 | 54 |
| Stress at 50% | MPa | 5.8 | 5.8 |
| Stress at 100% | MPa | 7.1 | 7.2 |
| Stress at 200% | MPa | 9.5 | 9.8 |
| Stress at 300% | MPa | 12 | |
| Stress at break | MPa | 12.1 | 10.9 |
| Standard deviation | MPa | 0.4 | 0.2 |
| Elongation at break | % | 306 | 246 |
| Standard deviation | % | 9 | 6 |
| Tear strength | N/mm | 29.41 | 29.98 |
| Standard deviation | N/mm | 0.08 | 0.12 |

This Table 4 shows that the high-temperature compression set is improved.

TABLE 5
Composition of the compounds

| Composition | T0 | T1 | T2 | T3 |
|---|---|---|---|---|
| SBR Buna VSL 5525-1 | 103.12 | 103.12 | 103.12 | 103.12 |
| 1,4-cis BR | 25 | 25 | 25 | 25 |
| (Cariflex 1220) | | | | |
| 1165 MP silica | 80 | 80 | 80 | 80 |
| Mobilsol K oil | 4.38 | 4.38 | 4.38 | 4.38 |
| B-grade white ZnO | 2.5 | 2.5 | 2.5 | 2.5 |
| Stearic acid | 2.5 | 2.5 | 2.5 | 2.5 |
| 6PPD | 2 | 2 | 2 | 2 |
| Antilux 500 | 1.5 | 1.5 | 1.5 | 1.5 |
| X50S silane | 12.8 | 12.8 | 12.8 | 12.8 |
| MBS | 0 | 5 | 10 | 20 |
| N300 black | 2.4 | 2.4 | 2.4 | 2.4 |
| Micronized sulphur, | 1.4 | 1.4 | 1.4 | 1.4 |
| 300 mesh | | | | |
| CBS | 1.7 | 1.7 | 1.7 | 1.7 |
| DPG | 2 | 2 | 2 | 2 |

Operating Method for Producing the Compounds:

All the ingredients were introduced at the start with the rubber, with the exception of the cure agents (sulphur, etc.). The compound was then mixed until it reached the temperature of 170° C. by self-heating. It was then cooled on a calendar and the cure agents were then added to it.

TABLE 6
Rheometric properties at 170° C. (ISO 3417)

| | Min. torque | Max. torque | ts(2) | tc(90) | t(RH) | RH |
|---|---|---|---|---|---|---|
| Reference | ML (N · m)* | MH (N · m)* | (min, s) | (min, s) | (min, s) | (N · m)* |
| T0 | 1.66 (14.7) | 7.93 (70.2) | 2.23 | 15.06 | 4.26 | 0.037 (0.33) |
| T1 | 1.73 (15.3) | 7.67 (67.9) | 2.30 | 20.15 | 4.57 | 0.030 (0.27) |
| T2 | 1.75 (15.5) | 7.74 (68.5) | 2.41 | 21.43 | 5.09 | 0.028 (0.25) |
| T3 | 1.60 (14.2) | 7.32 (64.8) | 2.53 | 22.33 | 5.38 | 0.025 (0.22) |

*values in brackets are in lb. inch.

TABLE 7
Mooney viscosity index ML(1 + 4) at 100° C. (ISO 289-1)

| | |
|---|---|
| T0 | 66 |
| T1 | 68 |
| T2 | 67 |
| T3 | 65 |

TABLE 8
135° C. precure test (ISO 289-2)

| | | | | min. | |
|---|---|---|---|---|---|
| | t5 (min, | t35 | t35-5 | torque | RH |
| Reference | sec) | (min, sec) | (min, sec) | (N · m)* | (N · m)* |
| T0 | 13.18 | 19.46 | 6.28 | 6.45 (57.1) | 0.008 (0.08) |
| T1 | 14.09 | 20.55 | 6.46 | 6.61 (58.5) | 0.007 (0.07) |
| T2 | 14.46 | 21.45 | 6.59 | 6.63 (58.7) | 0.007 (0.07) |
| T3 | 15.06 | 20.44 | 6.38 | 6.2 (56.8) | 0.006 (0.06) |

*values in brackets are in lb. inch.

TABLE 9
170° C. cure time for sheets and test specimens

| Reference | T0 | T1 | T2 | T3 |
|---|---|---|---|---|
| 2-mm thick sheets (min, sec) | 16 | 20 | 24 | 25 |
| Goodrich blocks (min, sec) | 18 | 22 | 26 | 29 |

TABLE 10
Shore 1 hardness measurement (ISO 7619)

| Reference | Instantaneous | after 15 seconds |
|---|---|---|
| T0 | 73 | 67.9 ± 0.5 |
| T1 | 75 | 67.6 ± 0.2 |
| T2 | 76 | 67.0 ± 0.3 |
| T3 | 76 | 69.1 ± 0.3 |

TABLE 11
Tensile properties (ISO 37)

| | | Elongation | | | | | |
|---|---|---|---|---|---|---|---|
| | Tensile strength | at break | σ (50%) | σ (100%) | σ (200%) | σ (300%) | |
| Ref. | (MPa) | (MPa) | (MPa) | (MPa) | (MPa) | (MPa) | σ₃₀₀/σ₁₀₀ |
| T0 | 20.2 | 404 | 1.55 | 2.72 | 7.50 | 13.9 | 5.1 |
| T1 | 21.5 | 444 | 1.59 | 2.84 | 7.91 | 14.6 | 5.1 |
| T2 | 22.6 | 472 | 1.62 | 2.55 | 7.01 | 13.4 | 5.25 |
| T3 | 22.3 | 518 | 1.65 | 2.51 | 6.46 | 12.1 | 4.8 |

TABLE 12
Tear strength (ISO 34-2)

| Reference | Delft (N) |
|---|---|
| T0 | 46.6 |
| T1 | 49.5 |
| T2 | 54.3 |
| T3 | 59.5 |

TABLE 13
Dynamic viscoelastic characterization

| | | | | |
|---|---|---|---|---|
| Reference | E* (MPa) | E′ (MPa) | E″ (MPa) | tan δ |

at 0° C.

| | | | | |
|---|---|---|---|---|
| T0 | 52.3 | 45.5 | 25.8 | 0.57 |
| T1 | 52.5 | 46.3 | 24.7 | 0.53 |
| T2 | 53.3 | 46.4 | 25.0 | 0.54 |
| T3 | 54.5 | 47.6 | 24.0 | 0.50 |

at 70° C.

| | | | | |
|---|---|---|---|---|
| T0 | 16.0 | 15.8 | 2.1 | 0.14 |
| T1 | 14.4 | 14.0 | 1.8 | 0.13 |
| T2 | 16.7 | 16.4 | 2.7 | 0.17 |
| T3 | 14.6 | 14.4 | 2.1 | 0.15 |

These examples show that by introducing the MBS in tyre formulations, the compositions are given an increase in their tear strength. This is an indication (under repeated mechanical stressing in use) of a reduction in crack propagation speed and better fatigue behaviour, without the other characteristics important for the application (hardness, tensile properties, dynamic viscoelastic properties) being modified. This is an improvement over the existing crosslinked formulations.

TABLE 14

| | 1 | 2 |
|---|---|---|
| BR (Budene 1207G) | 25.00 | 25.00 |
| SSBR (VSL 5025-1HM) | 75.00 | 75.00 |
| MBS | | 10.00 |
| IPPD | 2.00 | 2.00 |
| Budene 1207G | | |
| VSL 5025-1HM | | |
| Silica (Zeopol 8745) | 65.00 | 65.00 |
| Silane (Z6945) | 10.40 | 10.40 |
| Processing aid (Sundex 790 TN) | 5.00 | 5.00 |
| Stearic acid | 1.00 | 1.00 |
| Sulphur | 1.40 | 1.40 |
| Zinc oxide | 2.50 | 2.50 |
| Accelerator (CBS) | 1.70 | 1.70 |
| Accelerator (TMTD) | 1.00 | 1.00 |
| ML (dNm) | 8.4 | 8.2 |
| MH (dNm) | 37.20 | 38 |
| MH-ML (dNm) | 29.80 | 29.80 |
| ts2 (min) | 0.75 | 0.80 |
| tc90 (min) | 1.61 | 1.84 |
| Shore A (ASTM D 2240) | | |
| Hardness | 65 | 67 |
| Tests according to ASTM D 412, D 624) | | |
| Tensile strength* (MPa) | 17.53 (2543) | 16.63 (2412) |
| Elongation (%) | 277 (277) | 305 (305) |
| Stress 50% (MPa)* | 2.38 (345) | 3.31 (480) |
| Stress 100% (MPa)* | 4.98 (722) | 6.03 (875) |
| Stress 300% (MPa)* | 6.65 (964) | 9.73 (1412) |
| Tear strength ^{$}(N · m) | 28.70 (254) | 35.59 (315) |

*values in brackets are in psi;
^{$}values in brackets are in lb · inch.

It may be seen in these formulations (also used for manufacturing tyres) that again the incorporation of MBS significantly increases the tear strength, while at the same time, in this example, increasing the module. Again this provides a useful compromise of properties, limiting the deformation while reinforcing the composition.

1. Crosslinked composition comprising:
20 to 100 parts by weight of at least one elastomer (I);
2 to 50 parts by weight of at least one core-shell copolymer (II); and
0 to 100 parts by weight of at least one thermoplastic polymer (III), the components (I), (II) and (III) being different in chemical nature and/or of different structure.

2. The composition according to claim 1, in which the elastomer (I) is a compound is selected from the group consisting of natural rubbers, synthetic rubbers, ethylene-propylene rubbers (EPRs), ethylene-propylene-diene monomers (EPDMs), modified or unmodified polyolefin elastomers, metallocene-polymerized elastomers, octene/ethylene copolymers, long-chain polyacrylates, polybutyl acrylate, poly(2-ethylhexyl acrylate), fluoroelastomers (FPM), tetrafluoroethylene-based copolymers, and silicone elastomers.

3. The composition according to claim 2, in which the elastomer (I) is an octene/ethylene copolymer.

4. The composition according to claim 1, characterized in that it said composition is converted like a thermoplastic.

5. The composition according to claim 1, in which the thermoplastic polymer (III) is chosen from grafted polyolefins selected from the group consisting of polyethylenes, polypropylenes and ethylene-propylene copolymers grafted with acrylic acid, maleic anhydride or glycidyl methacrylate.

6. The composition according to claim 1, wherein said composition contains, before crosslinking, at least one crosslinking system comprising one or more crosslinking agents and one or more crosslinking promoters.

7. The composition according to claim 6, wherein the crosslinking system comprises, as crosslinking agent(s), one or more organic peroxides selected from the group consisting of dicumyl peroxide, 1,3-bis(t-butylperoxyisopropyl)benzene, 2,5-dimethyl-2,5-bis(t-butylperoxy)hexane and 1,1-bis(t-butylperoxy)-3,3,5-trimethylcyclohexane and, as crosslinking promoter(s), one or more compounds selected from the group consisting of zinc oxide, stearic acid, N,N-m-phenylenedimaleimide, triallyl or triisoallyl cyanurates, dimethacrylates, trimethacrylates, diacrylates and triacrylates.

8. The composition according to claim 6, wherein the crosslinking system is a sulphur-based crosslinking system and also contains zinc oxide and/or stearic acid, as crosslinking promoters, one or more sulphur-donor activators and, optionally, an anti-reversion agent.

9. The composition according to claim 6, wherein the crosslinking system comprises, as crosslinking agent, a phenolic resin chosen from reactive alkylated methylphenol-formaldehyde and bromomethylphenol-formaldehyde resins and, as crosslinking promoter, a chlorinated polymer, optionally combined with zinc oxide and/or stearic acid.

10. The composition according to one of claim 6, wherein the crosslinking agent and the crosslinking promoter are present in an amount of between 0.5 and 12 parts by weight per 100 parts of said composition.

11. The composition according to claim 1, further comprising a plasticizer and/or fillers of the light-coloured type, or carbon blacks and/or additives.

12. Process for producing the crosslinked composition of claim 1, which comprises the compounding of at least one elastomer (I), at least one core-shell copolymer (II) optionally in the presence of a thermoplastic polymer (III), a plasticizer, fillers and additives, this compound being crosslinked by an appropriate crosslinking system at a suitably chosen temperature.

13. Process according to claim 12, in which the crosslinking is carried out at a temperature of between 150 and 320° C.

14. Process according to claim 12, in which the crosslinking is carried out for a time of between 1 and 15 minutes.

15-20. (canceled)

21. The composition according to claim 1 comprising an article.

22. The composition according to claim 21, wherein said article is selected from the group consisting of insulating and/or leakproof seals and gaskets, pipes, hoses, tubing, couplings, electrical cable jackets, tires, belts, and shoe soles.
